(19) United States
(12) Patent Application Publication
(10) Pub. No.: US 2008/0175120 A1
(43) Pub. Date: Jul. 24, 2008

(54) OPTICAL DISC APPARATUS AND OPTICAL DISC RECORDING AND REPRODUCTION METHOD

(75) Inventors: Tatsuji Ashitani, Tokyo (JP); Yuichi Ito, Tokyo (JP); Takahiko Mihara, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/960,431

(22) Filed: Dec. 19, 2007

(30) Foreign Application Priority Data
Dec. 22, 2006 (JP) 2006-345692

(51) Int. Cl. G11B 27/36

(52) U.S. Cl. 369/59.12

(57) ABSTRACT

To form recording waveforms optimal to all optical discs including unknown discs and inferior quality discs. In an optical disc apparatus according to the present invention, a CPU changes a previously set pulse width at a predetermined code length by a predetermined value and controls an optical pickup, an RF amplifier, an evaluation index measurement circuit, and the like. With use of the changed pulse width, an asymmetry of a reproduction signal at the time of recording and reproducing test data on the optical disc is measured. On the basis of the measured asymmetry of the reproduction signal, a correction value for correcting the previously set pulse width at the predetermined code length is calculated. On the basis of the calculated correction value, the pulse width at the predetermined code length is corrected.

### BACKGROUND OF THE INVENTION

1. Field of the Invention

The present invention relates to an optical disc apparatus and an optical disc recording and reproduction method. In particular, the invention relates to an optical disc apparatus and an optical disc recording and reproduction method with which a write strategy can be corrected.

2. Description of the Related Art

In recent years, a technology has been proposed for deciding record parameters (for example, a record power, a write strategy, etc.) which are optimal to an individual recordable disc when data is recorded on the recordable optical disc such as a CD (compact Disc)—R/RW, a DVD (Digital Versatile Disc)—R/RW, or an HD (High Definition)—DVD-R/RW. According to the technology, while record parameters (for example, a record power, a write strategy, etc.) are changed, test data is written on trial in a predetermined area of the disc area (PCA (Power Calibration Area)), and the written test data is reproduced to decide the optimal record parameters.

As the technology for deciding the optimal record parameters, for example, a technology for deciding optimal record parameter by using asymmetry (asymmetry property) and jitter of a reproduction signal has been known.

In recent years, along with a trend of setting a higher density in the optical discs, in order to secure an S/N ratio and reduce an inter-symbol interference, a PRML (Partial Response and Maximum likelihood) identification system has been adopted. In this PRML identification system, a PR (Partial Response) characteristic in accordance with a recording and reproduction characteristic is used.

A technology with which the optimal record parameters can be decided in the optical disc apparatus adopting this PRML identification system has been proposed (for example, refer to Japanese Unexamined Patent Application Publication No. 2002-208136).

According to the technology proposed in Japanese Unexamined Patent Application Publication No. 2002-208136, formation of a recording waveform for a writing system optical disc, measurement of a reproduction signal, and analysis of the optical recording waveform can be automatically performed. With this configuration, an evaluation time for the writing system optical disc can be reduced and the write strategy optimal to the media can be easily analyzed.

However, according to the technology proposed in Japanese Unexamined Patent Application Publication No. 2002-208136, the formation of a recording waveform for the writing system optical disc, the measurement of the reproduction signal, and the analysis of the optical recording waveform can be automatically performed, but a large number of types exist as the optical disc on which user data is recorded (for example, a DVD-ROM, a DVD-R, and the like), and also characteristic features thereof vary depending on product manufacturers. Therefore, in order to automatically perform these analyses on the basis of the technology proposed in Japanese Unexamined Patent Application Publication No. 2002-208136, it is at least necessary to previously store initial values of recording parameters in accordance with the respective optical discs in a memory.

Furthermore, the manufacturers constantly propose new types of optical discs, and also the manufactured optical discs of the same type (for example, a DVD-RW or the like) have largely different product qualities depending on manufacturing factories. Even when the initial values of the recording parameters are set for all the optical discs existing when the optical disc apparatus is manufactured and the set recording parameters are stored in the memory, recording parameters optimal to unknown optical discs or inferior quality optical discs cannot be decided. Thus, there is a problem that the optimal recording waveform cannot be formed when the user data is recorded.

In addition to the above, the recording quality (recording integrity) can be guaranteed only to the good quality optical discs (recommended manufacturer's optical discs and the like) which exist when the optical disc apparatus is manufactured. Still, it is extremely difficult to automatically form the recording waveforms optimal to all the optical discs including unknown discs and inferior quality discs.

### SUMMARY OF THE INVENTION

The present invention has been made in view of the above and accordingly it is an object of the invention to provide an optical disc apparatus and an optical disc recording and reproduction method in which it is possible to automatically form recording waveforms optimal to all optical discs including unknown discs and inferior quality discs.

In order to solve the above-mentioned problems, according to an aspect of the present invention, there is provided an optical disc apparatus, including: a change unit configured to change a previously set pulse width at a predetermined code length by a predetermined value; a measurement unit configured to measure an asymmetry of a reproduction signal at a time of recording and reproducing test data on a disc, by using the pulse width changed by the change unit; a calculation unit configured to calculate a correction value for correcting the previously set pulse width at the predetermined code length on the basis of the asymmetry of the reproduction signal measured by the measurement unit; and a correction unit configured to correct the pulse width at the predetermined code length on the basis of the correction value calculated by the calculation unit.

In order to solve the above-mentioned problems, according to another aspect of the present invention, there is provided an optical disc recording and reproduction method for an optical disc apparatus, the method including: a change step of changing a previously set pulse width at a predetermined code length by a predetermined value; a measurement step of measuring an asymmetry of a reproduction signal at a time of recording and reproducing test data on a disc, by using the pulse width changed in a processing in the change step; a calculation step of calculating a correction value for correcting the previously set pulse width at the predetermined code length on the basis of the asymmetry of the reproduction signal measured in a processing in the measurement step; and a correction step of correcting the pulse width at the predetermined code length on the basis of the correction value calculated in a processing in the calculation step.

In the optical disc apparatus according to the present invention, the previously set pulse width at the predetermined code length is changed by the predetermined value, the asymmetry of the reproduction signal at the time of recording and reproducing the test data on the disc is measured by using the changed pulse width, the correction value for correcting the previously set pulse width at the predetermined code length is measured on the basis of the measured asymmetry of the reproduction signal, and the pulse width at the predetermined code length is corrected on the basis of the calculated correction value.

In the optical disc recording and reproduction method for an optical disc apparatus according to the present invention, the previously set pulse width at the predetermined code length is changed by the predetermined value, the asymmetry of the reproduction signal at the time of recording and reproducing the test data on the disc is measured by using the changed pulse width, the correction value for correcting the previously set pulse width at the predetermined code length is measured on the basis of the measured asymmetry of the reproduction signal, and the pulse width at the predetermined code length is corrected on the basis of the calculated correction value.

According to the present invention, it is possible to form the recording waveforms optimal to all the discs including unknown discs and inferior quality discs.

### BRIEF DESCRIPTION OF THE DRAWINGS

FIG. 1 is a block diagram of an internal configuration of an optical disc apparatus according to a first embodiment of the present invention;

FIG. 2 is an explanatory diagram for describing a measurement method of an asymmetry property (asymmetry) of a reproduction signal;

FIG. 3 is an explanatory diagram for describing an edge timing (pulse width) of a pulse;

FIGS. 4A1, 4A2, and 4B are explanatory diagrams for describing pulse width adjusting parameters for adjusting the pulse width;

FIGS. 5A to 5D illustrate changes of the pulse width adjusting parameters for adjusting the pulse width when the pulse width is changed;

FIG. 6 is a flowchart for describing a recording parameter decision processing in the optical disc apparatus illustrated in FIG. 1;

FIG. 7 is a graph representing changes in asymmetry when the pulse width is changed;

FIG. 8 illustrates a calculation expression for calculating a correction amount of the pulse width;

FIG. 9 is a block diagram of an internal configuration of an optical disc apparatus according to a second embodiment of the present invention;

FIG. 10 illustrates an example of a particular pattern generated in a particular pattern generator of FIG. 9;

FIG. 11 is a flowchart for describing a recording parameter decision processing in the optical disc apparatus illustrated in FIG. 9;

FIG. 12 is a flowchart for describing the recording parameter decision processing in the optical disc apparatus illustrated in FIG. 9; and

FIG. 13 illustrates an experiment result of an asymmetry of reproduction signals in a case where a particular pattern pulse width correction processing in Step S21 of FIG. 11 is executed.

### DESCRIPTION OF THE PREFERRED EMBODIMENTS

Hereinafter, embodiments of the present invention will be described with reference to the drawings.

### First Embodiment

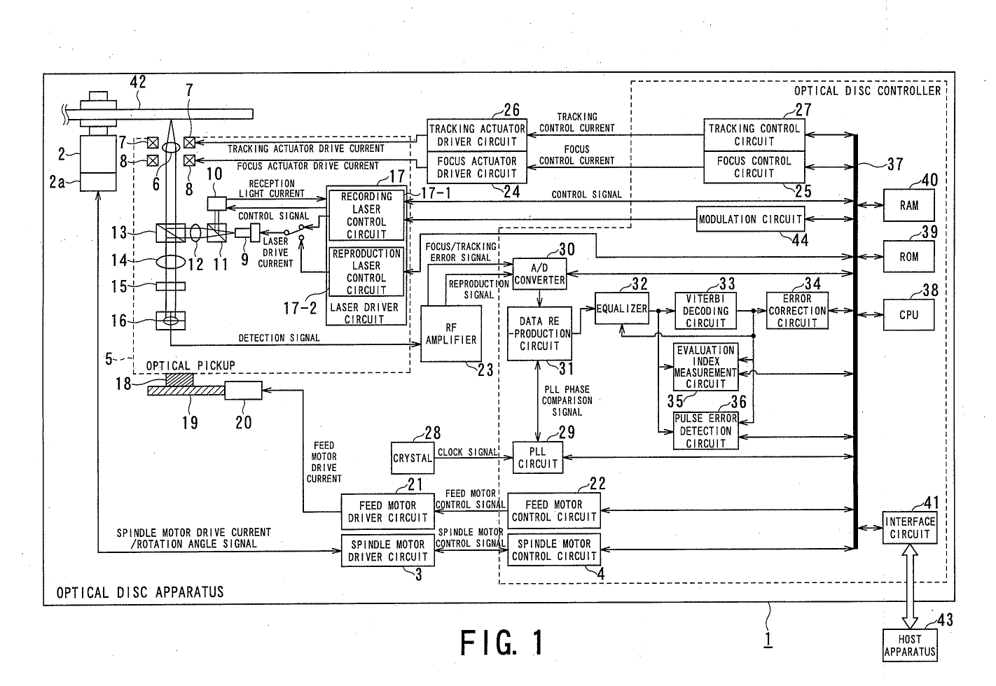

FIG. 1 illustrates a configuration of an optical disc apparatus 1 according to a first embodiment of the present invention.

The optical disc apparatus 1 is adapted to perform recording and reproduction of information with respect to an optical disc 42, for example, a DVD (Digital Versatile Disc)—R/RW, a HD (High Definition)—DVD-R/RW, or the like functioning as information recording. The optical disc 42 has grooves formed concentrically or spirally. A concave part of the groove is referred to as land, and a convex part thereof is referred to as groove. A circle of the groove or the land is referred to as track. User data is recorded on the optical disc 42 while an intensity-modulated laser beam is emitted along this track (only the groove, or the groove and the land) and record marks are formed. Data reproduction is performed by detecting a change in reflection light intensity due to the record marks on the track while a laser beam with a read power which is weaker the power during the recording is emitted along the track. Deletion of the recorded data is performed through crystallization of a recording layer by emitting a laser beam with an erase power which is stronger than the read power along the track.

The optical disc 42 is rotated and driven by a spindle motor 2. A rotation angle signal is output from a rotary encoder 2a which is provided to the spindle motor 2, to a spindle motor driver circuit 3. When the spindle motor 2 makes one rotation, the rotation angle signal generates, for example, five pulses. With this configuration, a spindle motor control circuit 4 can determine the rotation angle and the number of rotations of the spindle motor 2 on the basis of the rotation angle signal input from the rotary encoder 2a via the spindle motor driver circuit 3. The spindle motor 2 is controlled by the spindle motor control circuit 4.

Recording or reproduction of information with respect to the optical disc 42 is performed by an optical pickup 5. The optical pickup 5 is linked to a feed motor 20 via a gear 18 and a screw shaft 19, and the feed motor 20 is controlled by a feed motor driver circuit 21. As the feed motor 20 is rotated with a feed motor drive current supplied from the feed motor driver circuit 21, the optical pickup 5 is moved in a radius direction of the optical disc 42.

The optical pickup 5 is provided with an objective lens 6 supported by a wire or a plate spring which is not illustrated in the drawing. The objective lens 6 can be moved in a focusing direction (an optical axis direction of the lens) by way of the drive of a focus actuator 8, and also be moved in a tracking direction (a direction perpendicular to the optical axis direction of the lens) by way of the drive of a tracking actuator 7.

A laser driver circuit 17 is composed of a recording laser control circuit 17-1 for generating a laser control signal for controlling a laser diode 9 at the time of recording and a reproduction laser control circuit 17-2 for generating a laser control signal for controlling the laser diode 9 at the time of reproduction. The laser driver circuit 17 supplies a write signal to a laser diode (laser light emitting element) 9 at the time of information recording (during mark formation) on the basis of the recording data (recording data modulated through an EFM modulation method, for example, in a modulation circuit 44) which is supplied from a host apparatus 43 via an interface circuit 41. Also, the laser driver circuit 17 supplies a read signal which is smaller than the write signal to the laser diode 9 at the time of information reading. It should be noted that in the laser driver circuit 17, edge timing fine adjustment information is previously set for each code length pattern called write strategy which is used for recording user data on the optical disc 42. On the basis of this edge timing fine adjustment information, a laser drive current (laser control signal) in which the edge timing has been adjusted is output to the laser diode 9.

A front monitor photodiode 10 branches a part of laser light generated by the laser diode 9 at a given ratio by using a half mirror 11, detects the quantity of light, in other words, a reception light signal in proportion to the irradiation power, and supplies the detected reception light signal to the laser driver circuit 17. The laser driver circuit 17 obtains the reception light signal supplied from the front monitor photodiode 10, and controls the laser diode 9 on the basis of the thus obtained reception light signal so that the laser diode 9 emits lights at a laser power (irradiation power) during the reproduction, at a laser power during the recording, and at a laser power during the deletion which are previously set by a CPU (Central Processing Unit) 38.

The laser diode 9 emits laser light in accordance with the signal supplied from the laser driver circuit 17. The laser light emitted from the laser diode 9 is emitted onto the optical disc 42 via a collimator lens 12, a half prism 13, and the objective lens 6. The reflection light from the optical disc 42 is guided to an optical detection device 16 via the objective lens 6, the half prism 13, a collective lens 14, and a cylindrical lens 15.

The optical detection device 16 is composed of, for example, four divisional optical detection cells, and adapted to generate a detection signal and output the thus generated detection signal to an RF amplifier 23. The RF amplifier 23 performs a processing on the detection signal supplied from the optical detection device 16. Also, the RF amplifier 23 generates a focus error signal (FE) indicating an error from the just focus, a tracking error signal (TE) indicating an error between the beam spot center of the laser light and the track center, and a reproduction signal (RF) which is a full addition signal of detection signals, and supplies to an A/D converter 30 the focus error signal (FE), the tracking error signal (TE), and the reproduction signal (RF) which have been thus generated.

A focus control circuit 25 generates a focus control signal in accordance with the focus error signal (FE) taken in from the RF amplifier 23 via the A/D converter 30 and supplies the thus generated focus control signal to a focus actuator driver circuit 24. The focus actuator driver circuit 24 supplies a focus actuator drive current for driving the focus actuator 8 to the focus actuator 8 in the focusing direction on the basis of the focus control signal supplied from the focus control circuit 25. With this configuration, a focus servo is conducted so that the laser light regularly has the just focus on the recording layer of the optical disc 42.

A tracking control circuit 27 generates a tracking control signal in accordance with the tracking error signal (TE) taken in from the RF amplifier 23 via the A/D converter 30 and supplies the thus generated tracking control signal to a tracking actuator driver circuit 26. The tracking actuator driver circuit 26 supplies a tacking actuator drive current for driving the tracking actuator 7 to the tracking actuator 7 in the tracking direction on the basis of the tracking control signal supplied from the tracking control circuit 27. With this configuration, a tracking servo is conducted so that the laser always traces the track formed on the optical disc 42.

While such focus servo and tracking servo are conducted, the change in reflection light from the bit or the like formed on the track of the optical disc 42 corresponding to the recorded information reflects the reproduction signal (RF) which is the full addition signal of the detection signals from the optical detection device 16 (the respective optical detection cells). This reproduction signal is an ultraweak analog signal. The reproduction signal is amplified by the RF amplifier 23 and sampled in the A/D converter 30 at a constant frequency, and thereafter supplied to a data reproduction circuit 31. Also, the data reproduction circuit 31 performs corrections on the amplitude and offset of the reproduction signal supplied from the A/D converter 30 and converts the reproduction signal into a signal synchronism with a reproduction clock signal in the PLL (Phase Locked Loop) circuit 29 before being output to an equalizer 32.

The equalizer 32 uses an arbitrary PR characteristic to convert the reproduction signal input from the data reproduction circuit 31 into an equalized reproduction signal close to the arbitrary PR characteristic, and outputs the converted equalized reproduction signal to a Viterbi decoding circuit 33, an evaluation index measurement circuit 35, and a pulse error detection circuit 36. The Viterbi decoding circuit 33 selects a path having the smallest Euclidean distance to the equalized reproduction signal which is input from the equalizer 32, outputs a sign bit sequence corresponding to the selected path to an error correction circuit 34 as decoded data, and also outputs this decoded data to the equalizer 32, the evaluation index measurement circuit 35, and the pulse error detection circuit 36 as well.

The evaluation index measurement circuit 35 calculates, for example, PRSNR (Partial Response Signal to Noise Ratio), SbER (Simulated Bit Error Rate), an asymmetry, and the like as the evaluation index of the reproduction signal on the basis of the equalized reproduction signals and the decoded data respectively input from the equalizer 32 and the Viterbi decoding circuit 33. Then, the evaluation index measurement circuit 35 supplies data related to the calculated PRSNR, SbER, asymmetry and the like to the CPU 38 via the bus 37. At this time, when the equalized reproduction signals are subjected to the Viterbi decoding in the Viterbi decoding circuit 33, the equalized reproduction signal are sorted (discriminated) for each code length (for example, 2T, 3T, and the like). At the same time, it is possible to obtain the respective crest values of the reproduction signals. Thus, the asymmetry of the reproduction signal is calculated by calculating the average of the thus obtained crest values of the reproduction signals.

The pulse error detection circuit 36 uses the technology disclosed in, for example, Japanese Unexamined Patent Application Publication No. 2004-63204 to detect the pulse error of the reproduction signals on the basis of the equalized reproduction signals and the decoded data respectively input from the equalizer 32 and the Viterbi decoding circuit 33.

The CPU 38 performs various arithmetic processings on digital signals such as the focus error signal (FE) and the tracking error signal (TE), which have been converted into the digital signals via the A/D converter 30 after being output from the RF amplifier 23 to control the spindle motor control circuit 4, a feed motor control circuit 22, the focus control circuit 25, and the tracking control circuit 27.

In addition, the laser driver circuit 17, a PLL circuit 29, the A/D converter 30, the error correction circuit 34, the evaluation index measurement circuit 35, the pulse error detection circuit 36, and other components are controlled by the CPU 38 via the bus 37. The CPU 38 executes various processings while following a program stored in a ROM (Read Only Memory) 39 and a program loaded on a RAM (Random Access Memory) 40 from the ROM 39 as well as operation commands supplied via the interface circuit 41 from the host apparatus 43. The CPU 38 generates various control signals to be supplied to the respective units, thus controlling the optical disc apparatus 1 in an overall manner.

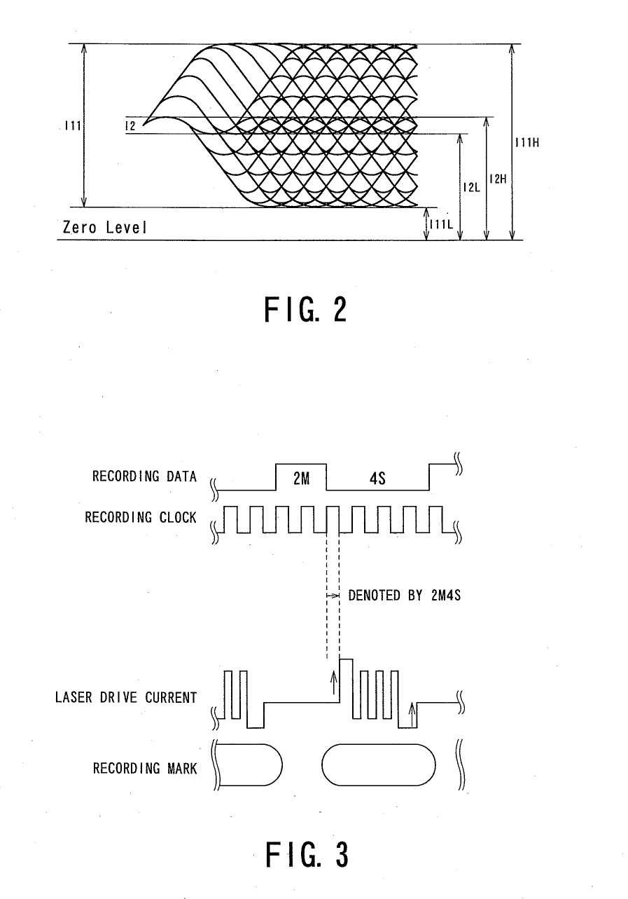

Incidentally, in the optical disc apparatus 1, when the asymmetry of the reproduction signal is measured by performing the recording and reproduction operation with use of the test data having a series of random patterns including all the code lengths (for example, 2T, 3T, and the like) in the evaluation index measurement circuit 35, for example, as illustrated in FIG. 2, the asymmetry of the respective code lengths included in the test data (for example, 2T, 3T, and the like) are measured.

In the case of the example illustrated in FIG. 2, while following [Expression 1], an asymmetry of 2T (2T mark and 2T space) is measured. For example, the 2T asymmetry is calculated as a DC component shift using the longest code length 11T as the reference.

$$2 T asymmetry = \\ [ ( I 11 H + I 11 L ) / 2 - ( I 2 H + I 2 L ) / 2 ] / ( I 11 H - I 11 L ) \qquad [ Expression 1 ]$$

Where I11H indicates a reproduction signal level of 11T mark included in the test data, I11L indicates a reproduction signal level of 11T space included in the test data, I2H indicates a reproduction signal level of 2T mark included in the test data, and I2L indicates a reproduction signal level of 2T space included in the test data.

Also, in the case of the example illustrated in FIG. 2, while following [Expression 2], an asymmetry of 3T (3T mark and 3T space) is measured.

$$3 T asymmetry = \\ [ ( I 11 H + I 11 L ) / 2 - ( I 3 H + I3L ) / 2 ] / ( I 11 H - I 11 L ) \qquad [ Expression 2 ]$$

Where I11H indicates the reproduction signal level of 11T mark included in the test data, I11L indicates the reproduction signal level of 11T space included in the test data, I3H indicates a reproduction signal level of 3T mark included in the test data, and I3L indicates a reproduction signal level of 3T space included in the test data.

According to the present invention, attention is paid on the asymmetry of the respective code length (for example, 2T, 3T, and the like). Hereinafter, a description will be given of a concept of a recording waveform optimization method with use of this asymmetry.

In general, in the write strategy used when the user data is recorded on the optical disc 42, it is possible to finely adjust (correct) the edge timing of the pulse with respect to combinations of short adjacent code lengths of several types (for example, a combination of 2T mark and 4T space, a combination of 3T mark and 5T space, and the like). To be more specific, for example, as illustrated in FIG. 3, in record data formed by a combination of code lengths in which 2T mark is followed by 4T space, for example, it is possible to finely adjust (correct) a rising edge or a trailing edge (edge timing) of the laser drive current at a front edge or a posterior edge.

In view of the above, for example, in a case of a modulation system where the shortest bit width is set as 1T and also the shortest code length is set as 2T, the pulse width (a predetermined pulse width among a multi pulse sequence used in the write strategy) with respect to four types of code lengths including 2T, 3T, 4T, and 5T among all the code lengths, for example, is finely adjusted (corrected).

Herein, a mark and a space are present for the respective code lengths (for example, 2T, 3T, and the like), and thus, as illustrated in FIG. 3, an edge timing at a posterior edge of 2T mark in a case where 2T mark is followed by 4T space is denoted as 2M4S.

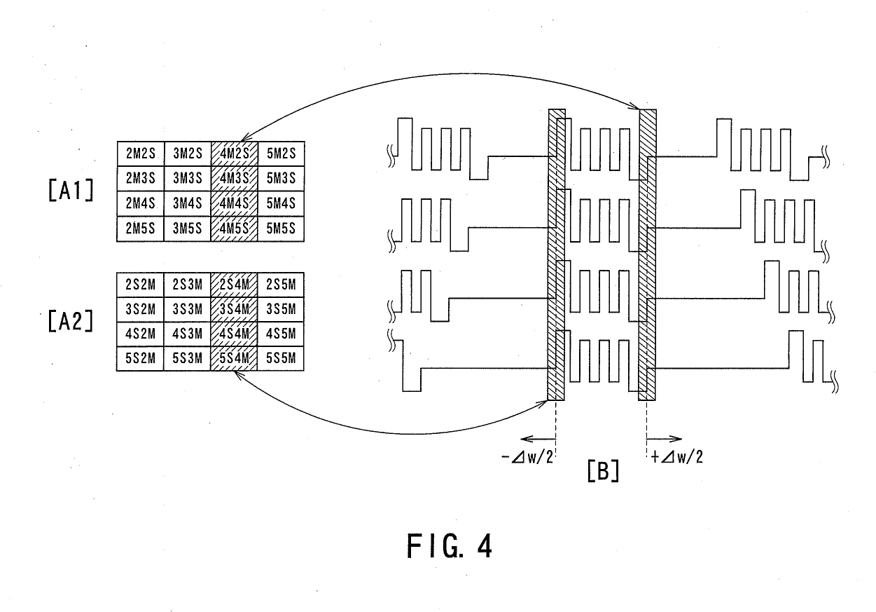

Accordingly, in a case where the pulse width is finely adjusted (corrected) with respect to the four types of code lengths including 2T, 3T, 4T, and 5T among all the code lengths, for example, when a consideration is given of the code lengths of the four types and the combinations of marks and spaces, as illustrated in FIGS. 4A1 and 4A2, pulse adjusting parameters of total 32 types including 2M2S to 5M5S and 2S2M to 5S5M are present at the front edge and the posterior edge, respectively.

It should be noted that according to the embodiment of the present invention, among all the code lengths, the pulse width is adjusted (corrected) from the shortest code length (for example, 2T) to the code lengths of the four types (for example, 2T to 5T), but the present invention is not limited to the above-mentioned case. The pulse width may be adjusted (corrected) with respect to code lengths of three types or code lengths of five or more types. That is, the code lengths of 3T to 5T may be used, or the code lengths of 2T to 13T may be used. However, a code length having a large influence from the inter-symbol interference is a short code length in particular. It is thus necessary to decide whether the fine adjustment is performed up to which code length in consideration for a trade-off relation between the memory of the laser driver circuit 17 and the control performance. Of course, as the present invention is applied to the short code length in particular which has a large influence from the inter-symbol interference the inter-symbol interference, it is possible to attain further significant effects, which is more preferable.

In the case of FIGS. 4A1, 4A2, and 4B, pulse width adjustment parameters for finely adjusting (correcting) the pulse widths at both the edges of 4T mark (in other words, edge timings) are represented in hatched parts. In the pulse widths at both the edges of 4T mark, the pulse width adjustment parameters are changed, and as illustrated in FIG. 4B, for example, by changing an average pulse width (initially set pulse width) by ±ΔW/2 at the front edge and the posterior edge, respectively, it is possible to change the pulse width, for example, to be expand by +ΔW or to be narrowed by −ΔW. It should be noted that by changing the pulse width, for example, to be expanded by +ΔW, it is possible to amplify the effective laser power when the code length is recorded. As a result, it is possible to deeply remove the asymmetry at the code length.

At this time, when the pulse width is changed by changing the pulse width adjustment parameters, the asymmetry of the reproduction signal is changed at the same time, and it is understood from experiences that a linear causal relation exists between the pulse width and the asymmetry. In view of the above, by using this linearity, for example, ΔW2, ΔW3, ΔW4, and ΔW5 at which the asymmetries of 2T to 5T are set as 0 are calculated, and it is possible to decide the recording parameters by finely adjusting (correcting) the initially set pulse width on the basis of the calculated ΔW2, ΔW3, ΔW4, and ΔW5. Hereinafter, a recording parameter decision processing in the optical disc apparatus 1 of FIG. 1 where this method is used will be described.

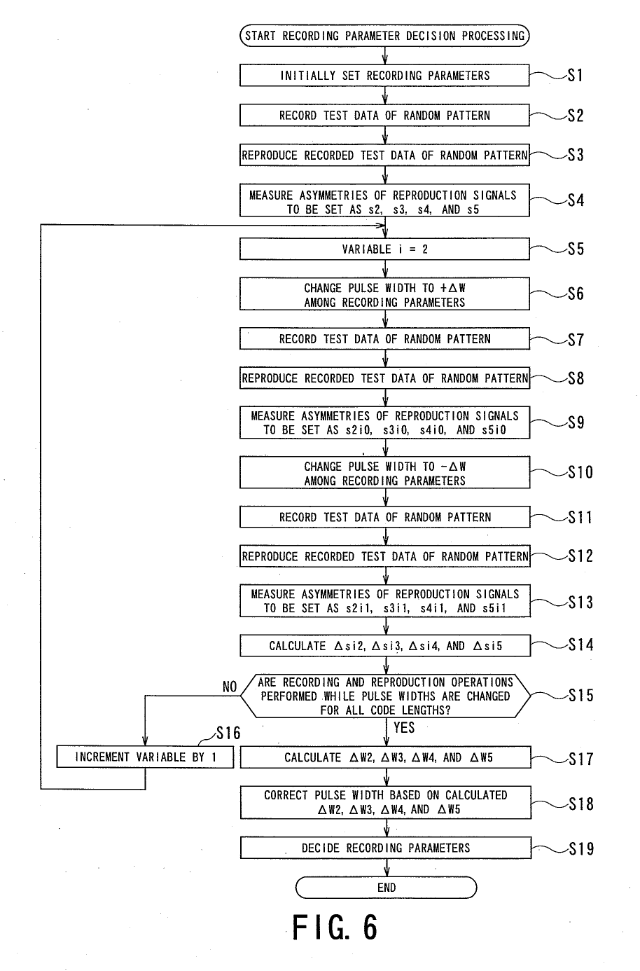

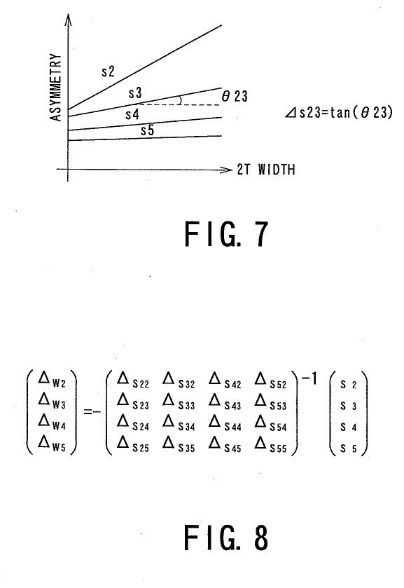

With reference to the flowchart of FIG. 6, the recording parameter decision processing in the optical disc apparatus 1 of FIG. 1. This recording parameter decision processing is previously started when the user data is recorded on the optical disc 42 as the user inserts the optical disc 42 into the optical disc apparatus 1 and operates an operation unit (not illustrated) of the host apparatus 43 to instruct the recording processing start.

It should be noted that in the flowchart of the recording parameter decision processing described with reference to FIG. 6, for example, a case in which the pulse width (the predetermined pulse width among a multi pulse sequence used in the write strategy) with respect to the code lengths of the four types including 2T to 5T among all the code lengths used when the user data is recorded on the optical disc 42 is finely adjusted (corrected) will be demonstratively described.

In Step S1, the CPU 38 reads out initial values of the recording parameters used when the user data is recorded on the optical disc 42 (for example, the recording power, the write strategy, etc.) from the ROM 39, and performs the initial setting of the recording parameters used for recording the user data on the optical disc 42 on the basis of the read initial values of the recording parameters.

In Step S2, the CPU 38 controls, via the bus 37, the optical pickup 5, the RF amplifier 23, the focus control circuit 25, the tracking control circuit 27, and the like, and uses the initially set recording parameters to perform the recording operation of the test data of a predetermined random pattern on a predetermined area of the optical disc 42 (PCA (Power calibration Area)). With this configuration, by using the initially set recording parameters, the data of the predetermined random pattern is recorded on the optical disc 42.

In Step S3, the CPU 38 controls the optical pickup 5, the RF amplifier 23, the focus control circuit 25, and the tracking control circuit 27 via the bus 37, and uses the initially set recording parameters to perform the reproduction operation on the recorded test data of the predetermined random pattern.

In Step S4, the CPU 38 controls the data reproduction circuit 31, the equalizer 32, the Viterbi decoding circuit 33, and the evaluation index measurement circuit 35, and measures the asymmetry of the reproduction signal (the asymmetry of the reproduction signal at each code length) at the time of recording and reproducing the test data of the predetermined random pattern.

To be more specific, the equalizer 32 uses an arbitrary PR characteristic to convert the reproduction signal input from the data reproduction circuit 31 into an equalized reproduction signal close to the arbitrary PR characteristic, and outputs the converted equalized reproduction signal to the Viterbi decoding circuit 33 and the evaluation index measurement circuit 35. The Viterbi decoding circuit 33 selects a path having the smallest Euclidean distance to the equalized reproduction signal which is input from the equalizer 32, and outputs a code length bit sequence corresponding to the selected path to the equalizer 32 and the evaluation index measurement circuit 35 as decoded data.

The evaluation index measurement circuit 35 calculates (measures) the asymmetry as the evaluation index of the reproduction signal on the basis of the equalized reproduction signal and the decoded data respectively input from the equalizer 32 and the Viterbi decoding circuit 33.

The calculated asymmetries of the current reproduction signals at the respective code lengths at this time, for example, 2T, 3T, 4T, and 5T, are denoted by s2, s3, s4, and s5.

The evaluation index measurement circuit 35 supplies data related to the calculated (measured) asymmetry to the CPU 38 via the bus 37. The CPU 38 obtains the data related to the asymmetry (the asymmetry of the reproduced signal at the time of recording and reproducing the test data of the random pattern) which is supplied from the evaluation index measurement circuit 35. The data regarding this asymmetry includes data related to the asymmetries s2, s3, s4, and s5 of the reproduction signals at the code lengths 2T, 3T, 4T, and 5T. The thus obtained data related to the asymmetries is temporarily stored in the RAM 39.

In Step S5, the CPU 38 sets an initial value of a variable i, which is a variable representing a current code length where the pulse width is changed, as i=2. That is, when the variable i is set as 2, through the following processing, after the pulse width at 2T is changed by +ΔW or −ΔW and the recording and reproduction are performed, the asymmetry of the reproduction signal is measured.

In Step S6, the CPU 38 reads out the initial values of the recording parameters (for example, the recording power, the write strategy, and the like) used for recording the user data on the optical disc 42 from the ROM 39, and initially sets the recording parameters used for used for recording the user data on the optical disc 42 on the basis of the read initial values of the recording parameters. Also, the CPU 38 performs the initial setting to change the pulse width among the recording parameters to +ΔW by changing the pulse width adjusting parameter.

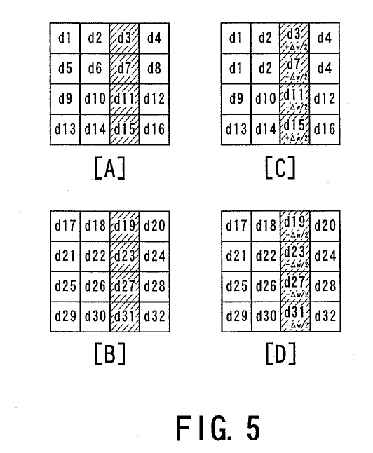

At this time, for example, as illustrated in FIG. 5A, when the initial value related to the pulse width adjusting parameter in the write strategy are set as d1 to d16, for example, when the pulse widths at both the edges of 4T mark (edge timings) are changed, as illustrated in FIG. 5C, the pulse width adjusting parameter is changed.

In Step S7, the CPU 38 controls the optical pickup 5, the RF amplifier 23, the focus control circuit 25, the tracking control circuit 27, and other components via the bus 37, and uses the initially set recording parameters to perform the recording operation of the test data of the predetermined random pattern in the predetermined area of the optical disc 42 (PCA (Power Calibration Area)). With this configuration, with use of the initially set recording parameters, the data of the predetermined random pattern is recorded in the predetermined area of the optical disc 42.

In Step S8, the CPU 38 controls the optical pickup 5, the RF amplifier 23, the focus control circuit 25, the tracking control circuit 27, and other components via the bus 37, and uses the initially set recording parameters to perform the reproduction operation of the test data of the predetermined random pattern.

In Step S9, the CPU 38 controls the data reproduction circuit 31, the equalizer 32, the Viterbi decoding circuit 33, and the evaluation index measurement circuit 35, and measures the asymmetry of the reproduction signal (the asymmetry of the reproduction signal at each code length) at the time of recording and reproducing the test data of the predetermined random pattern. It should be noted that the specific measurement method is similar to the measurement method described in Step S4 and a description thereof will be omitted to avoid the repetition.

Herein, the asymmetries of the reproduction signals at the code lengths 2T, 3T, 4T, and 5T measured after the recording and reproduction are performed while the pulse width iT is changed by +ΔW are denoted by s2i0, s3i0, s4i0, and s5i0. On the other hand, the asymmetries of the reproduction signals at the code lengths 2T, 3T, 4T, and 5T measured after the recording and reproduction are performed while the pulse width iT is changed by −ΔW are denoted by s2i1, s3i1, s4i1, and s5i1.

For example, the asymmetries of the reproduction signals at the code lengths 2T, 3T, 4T, and 5T measured after the pulse width at 2T is changed by +ΔW and the recording and reproduction are performed are denoted by s220, s320, s420, and s520. On the other hand, for example, the asymmetries of the reproduction signals at the code lengths 2T, 3T, 4T, and 5T measured after the pulse width at 2T is changed by −ΔW and the recording and reproduction are performed are denoted by s221, s321, s421, and s521.

In this case, through the processing in Step S5, the asymmetries s220, s320, s420, and s520 of the reproduction signals at the code lengths 2T, 3T, 4T, and 5T are calculated.

The evaluation index measurement circuit 35 supplies data related to the calculated (measured) asymmetry to the CPU 38 via the bus 37. The CPU 38 obtains the data related to the asymmetry (the asymmetry of the reproduced signal at the time of recording and reproducing the test data of the random pattern) which is supplied from the evaluation index measurement circuit 35. The data regarding this asymmetry includes data related to the asymmetries s220, s320, s420, and s520 of the reproduction signals at the code lengths 2T, 3T, 4T, and 5T.

In Step S10, the CPU 38 performs the initial setting to change the pulse width among the recording parameters to −ΔW by changing the pulse width adjusting parameter.

At this time, for example, as illustrated in FIG. 5B, when the initial value related to the pulse width adjusting parameter in the write strategy are set as d17 to d32, for example, when the pulse widths at both the edges of 4T mark (edge timings) are changed, as illustrated in FIG. 5D, the pulse width adjusting parameter is changed.

In Step S11, the CPU 38 controls the optical pickup 5, the RF amplifier 23, the focus control circuit 25, the tracking control circuit 27, and other components via the bus 37, and uses the initially set recording parameters to perform the recording operation of the test data of the predetermined random pattern in the predetermined area of the optical disc 42 (PCA (Power Calibration Area)). With this configuration, with use of the initially set recording parameters, the data of the predetermined random pattern is recorded in the predetermined area of the optical disc 42.

In Step S12, the CPU 38 controls the optical pickup 5, the RF amplifier 23, the focus control circuit 25, the tracking control circuit 27, and other components via the bus 37, and uses the initially set recording parameters to perform the reproduction operation of the test data of the predetermined random pattern.

In Step S13, the CPU 38 controls the data reproduction circuit 31, the equalizer 32, the Viterbi decoding circuit 33, and the evaluation index measurement circuit 35, and measures the asymmetry of the reproduction signal (the asymmetry of the reproduction signal at each code length) at the time of recording and reproducing the test data of the predetermined random pattern. It should be noted that the specific measurement method is similar to the measurement method described in Step S4 and a description thereof will be omitted to avoid the repetition.

In this case, asymmetries s221, s321, s421, and s521 of the reproduction signals at the code lengths 2T, 3T, 4T, and 5T are calculated in the process in Step S5.

The evaluation index measurement circuit 35 supplies data related to the calculated (measured) asymmetry to the CPU 38 via the bus 37. The CPU 38 obtains the data related to the asymmetry (the asymmetry of the reproduced signal at the time of recording and reproducing the test data of the random pattern) which is supplied from the evaluation index measurement circuit 35. The data regarding this asymmetry includes data related to the asymmetries s221, s321, s421, and s521 of the reproduction signals at the code lengths 2T, 3T, 4T, and 5T.

Herein, when the pulse width is changed by changing the pulse width adjustment parameters, the asymmetry of the reproduction signal is changed at the same time, and it is understood from experiences that a linear causal relation exists between the pulse width and the asymmetry. Also, it is understood from experiences that through the inter-symbol interference, for example, when the pulse width at 2T is changed by changing the pulse width adjusting parameter, not only the asymmetry of the reproduction signal at the code length 2T but also the asymmetries of the reproduction signals at other code lengths (for example, the code lengths 3T, 4T, 5T, etc.) are simultaneously changed.

For example, when the pulse width at 2T is changed, for example, as illustrated in FIG. 7, the asymmetry of the reproduction signal at each code length is linearly changed. At this time, when the pulse width at 2T is changed, among the asymmetries of the reproduction signals at the code lengths 2T to 5T, the asymmetry of the reproduction signal at the code length 2T is most significantly changed. Herein, a change in the asymmetry of the reproduction signal at the code length 3T when the pulse width 2T is changed is found out by way of tan (θ23) from an inclination of the straight line (θ23) and denoted by Δs23 (=tan (θ23)).

It should be noted that tan (θ23) is a value obtained by dividing the change amount of in the asymmetry of the reproduction signal by 2ΔW.

It should be noted that according to the embodiment of the present invention, by finding out an inclination between two plots when the pulse width is changed from −ΔW to +ΔW, the changes in the asymmetries of the reproduction signals at the respective code lengths are calculated. However, the present invention is not limited to the above-mentioned case. For example, an accurate change in the asymmetry may be calculated by finding out an inclination among three plots. Also, an optimal ΔW (the change amount in the pulse width) at which the linearity between the asymmetry of the reproduction signal and the change amount in the pulse width hardly falls apart can be experimentally decided.

In Step S14, on the basis of the thus obtained data related to the asymmetries of the reproduction signals at the respective code lengths the CPU 38, a change Δsij (j=2, 3, 4, and 5) in the asymmetries of the reproduction signals at the respective code length (2T, 3T, 4T, and 5T) when the pulse width iT is changed is calculated by finding out an inclination (θ) of the straight line. That is, in this case, on the basis of the thus obtained data related to the asymmetries s220, s320, s420, and s520 of the reproduction signals at the respective code length 2T, 3T, 4T, and 5T and the thus obtained data related to the asymmetries s221, s321, s421, and s521 of the reproduction signals at the code lengths 2T, 3T, 4T, and 5T, the changes Δs22, Δs23, Δs24, and Δs25 in the asymmetries of the reproduction signals at the respective code lengths at the time of changing the pulse width at 2T are calculated by way of tan (θ22), tan (θ23), tan (θ24), and tan (θ25) from inclinations of the straight lines (θ22, θ23, θ24, and θ25).

In Step S15, the CPU 38 determines whether the recording and reproduction operations are performed at all the code lengths or not while the pulse width is changed. In step S15, when it is determined that the recording and reproduction operations are not performed at all the code lengths while the pulse width is changed, the CPU 38 increments the variable i by 1 in Step S12. In this case, the variable i is incremented from 2 by 1 and is thus set as 3.

After that, the process is returned to Step S6, the processing in Step S6 and subsequent steps is repeatedly executed. That is, the asymmetry of the reproduction signal at the time of performing the recording and reproduction operations while the pulse width at 3T is changed by −ΔW and +ΔW is measured, and the measured changes Δs32, Δs33, Δs34, and Δs35 in the asymmetries of the reproduction signals at the respective code lengths are calculated.

Next, through the repeated execution of the process in Steps S6 to S16, furthermore, the asymmetries of the reproduction signals at the time of performing the recording and reproduction operations while the pulse widths at 4T and 5T are changed by −ΔW and +ΔW are measured, and the measured changes Δs42, Δs43, Δs44, and Δs45, and Δs52, Δs53, Δs54, and Δs55 in the asymmetries of the reproduction signals at the respective code lengths are calculated.

In Step S15, when it is determined that the recording and reproduction operations are performed at all the code lengths while the pulse width is changed, the CPU 38 calculates pulse width correction amounts ΔW2, ΔW3, ΔW4, and ΔW5 with which the current asymmetries at the respective code length in the optical disc 42 are set as 0 with use of a linear equation illustrated in FIG. 8 on the basis of the calculated Δs22 to Δs25, Δs32 to Δ35, Δs42 to Δs45, and Δs52 to Δs55 and further the current asymmetries s2 to s5 at the code lengths 2T to 5T (the asymmetries of the reproduction signals at the time of using the initial values).

In Step S18, the CPU 38 corrects the previously set initial values on the basis of the calculated pulse width correction amounts ΔW2, ΔW3, ΔW4, and ΔW5 (the pulse width correction amounts with which the current asymmetries at the respective code length in the optical disc 42 are set as 0).

In Step S19, the CPU 38 decides the current recording parameters (the recording power and the write strategy after the correction) as the recording parameters used for recording the user data on the optical disc 42.

According to the embodiment of the present invention, the pulse width among the recording parameters (that is, the edge timing) is changed for the respective code lengths (for example, 2T to 5T, etc.) by −ΔW or +ΔW from the previously set initial value. The recording and reproduction operations of the test data are performed by using the changed pulse width. The asymmetry of the reproduction signal at the respective code lengths (for example, 2T to 5T, etc.) is measured. The change in the measured asymmetry of the reproduction signal at the respective code lengths can be calculated from the straight line (θ) and also on the basis of the calculated change in the asymmetry of the reproduction signal and the current asymmetry of the reproduction signal at the time of using the pulse width at the initial value, the pulse width correction amounts with which the current asymmetries at the respective code length in the optical disc 42 are set as 0 (for example, ΔW2, ΔW3, ΔW4, and ΔW5) can be calculated.

In addition, it is possible to correct the previously set initial values on the basis of the calculated pulse width correction amounts (for example, ΔW2, ΔW3, ΔW4, and ΔW5) and the recording parameters optimal to the optical disc 42 can be decided.

With this configuration, even when a new type optical disc is proposed from the manufacturer after the production of the optical disc apparatus 1 or a product quality of the optical discs also differs depending on the manufacturing places, it is possible to form the recording waveforms optimal to all the optical discs 42 including unknown or inferior quality optical discs 42.

Therefore, the recording quality (recording integrity) in a case where the user data is recorded on the optical discs 42 can be improved. Also, variations due to the media (recording media) or the optical disc apparatuses 1 are suppressed, and it is possible to improve the yield and also achieve the reduction of the development time. Moreover, by implementing the present invention to the optical disc apparatus 1, it is possible to easily and automatically form the recording waveforms optimal to all the optical discs including unknown or inferior quality optical discs.

It should be noted that after the pulse width in the write strategy is corrected through the processing in Step S18 of FIG. 6, furthermore, for example, an edge timing adjustment may be performed by way of the inter-symbol interference with the pulse error detection circuit 36 though a method disclosed in Japanese Unexamined Patent Application Publication No. 2004-63024. The method disclosed in Japanese Unexamined Patent Application Publication No. 2004-63024 is a control method of removing the inter-symbol interference without actively causing the change in the asymmetry. By combining the edge timing adjustment with this control method, it is possible to obtain further satisfactory recording waveform.

In addition, in the recording parameter decision processing in the optical disc apparatus 1 of FIG. 1 which has been described with reference to the flowchart of FIG. 6, the pulse width for changing the effective power to change the asymmetry is changed. However, the present invention is not limited to the above-mentioned case. For example, the similar effects can be attained by changing the recording power at the respective code lengths (for example, 2T, 3T, and the like) instead of the pulse width. With this configuration, it is possible to expand a range where the change in the asymmetry can be corrected.

Furthermore, according to the embodiment of the present invention, after the recording and reproduction operations are performed by using the initial value of the pulse width at the previously set code length, the change in the asymmetry between the two plots where the pulse width is changed is further found out, and the pulse width correction amounts (for example, ΔW2, ΔW3, ΔW4, and ΔW5) with which the current asymmetries at the respective code length in the optical disc 42 are set as 0 are calculated. However, the present invention is not limited to the above-mentioned case. Instead of performing the recording and reproduction operations by using the initial value of the pulse width at the previously set code length, the asymmetry between the two plots where the pulse width is changed may be used to calculate the pulse width correction value.

Incidentally, in the recording parameter decision processing in the optical disc apparatus 1 of FIG. 1 which has been described with reference to the flowchart of FIG. 6, the recording and reproduction are performed by using the test data having a series of random patterns including all the code lengths. However, the present invention is not limited to the above-mentioned case. First, as a coarse adjustment, for example, the recording and reproduction are performed by using the test data having particular patterns formed by two code lengths xT and yT. After the pulse width is corrected from the previously set initial values set at the respective code lengths, the processing in Steps S5 to S18 of FIG. 6 in consideration for the inter-symbol interference may be executed as the fine adjustment. With this configuration, even when the reproduction signal is not locked in the PLL circuit 29 in an initial stage, it is unnecessary to perform code discrimination in a stage of the coarse adjustment. Therefore, after the pulse width is roughly corrected in the stage of the coarse adjustment, it is possible to perform the fine adjustment in a state where the reproduction signal is easily locked in the PLL circuit 29 in a satisfactory manner. Thus, it is possible to form the recording waveforms optimal to the inferior quality discs 42. Hereinafter, a description will be given of a second embodiment of the present invention.

### Second Embodiment

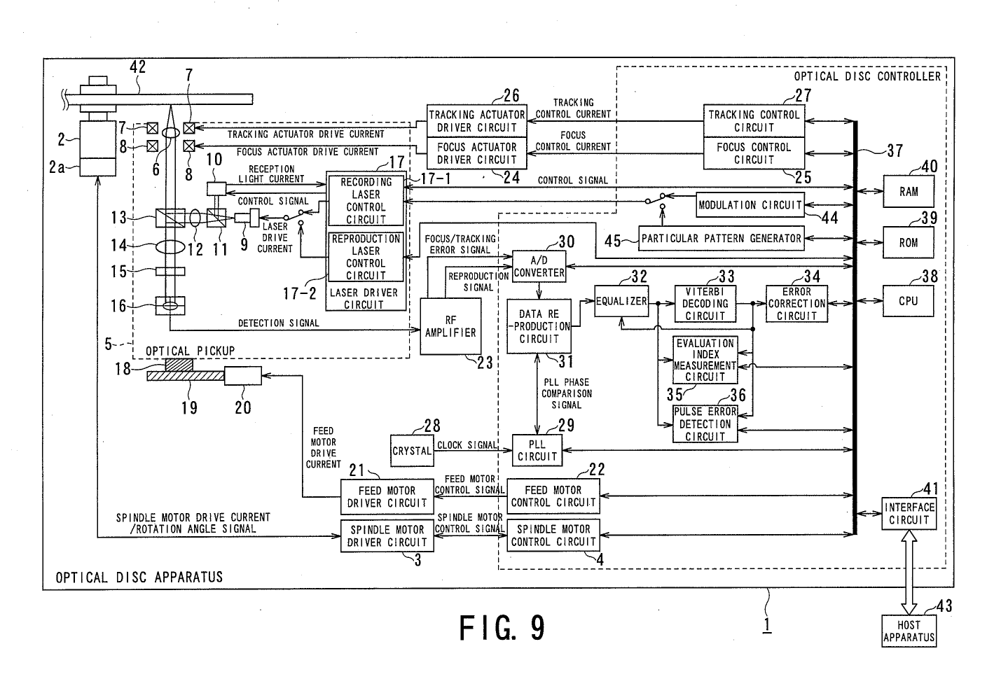

FIG. 9 illustrates a configuration of the optical disc apparatus 1 according to the second embodiment of the present invention. Components corresponding to those in the optical disc apparatus 1 of FIG. 1 are allocated with the same reference numerals and a description thereof will be omitted to above the repetition.

In accordance with the control of the CPU 38, a particular pattern generator 45 generates a particular pattern formed by a particular code length (for example, 2T, 3T, and the like) of the test data used when the recording and reproduction operation is performed on the optical disc 42 to measure the asymmetry of the reproduction signal, and outputs the test data having the particular pattern based on the thus generated particular pattern to the laser driver circuit 17.

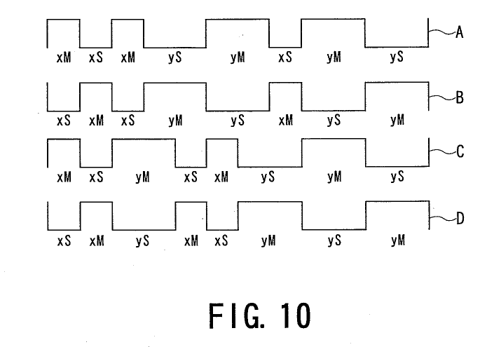

To be more specific, for example, as illustrated in FIG. 10, such a particular pattern is generated that all the inter-symbol interferences related to the two codes lengths xT and yT (the shortest code length≦x, y≦the longest code length) are included and the DSV (Digital Sum Value) becomes 0. After the test data having the particular pattern based on the thus generated particular pattern is recorded on the optical disc 42, the test data having the recorded particular pattern is reproduced and the asymmetry of the reproduction signal is measured.

It should be noted that in the particular pattern formed by the two codes lengths xT and yT, there are a plurality of isotopes (four isotopes) represented by particular patterns A to D of FIG. 10. In a case where the particular pattern are formed by the two codes lengths xT and yT, no consideration is given to three or more continuous inter-symbol interferences, and thus dispersions are somewhat caused in the asymmetries among the four isotopic particular patterns. For that reason, after the asymmetry is measured by using the test data having the four particular patterns, an average value of the measured four asymmetries is calculated.

With this configuration, it becomes unnecessary to perform the discrimination on the reproduction signals in view of the code lengths (for example, 2T, 3T, and the like). Thus, irrespective of the lock state of the reproduction signal in the PLL circuit 29, the asymmetry of the reproduction signal can be measured.

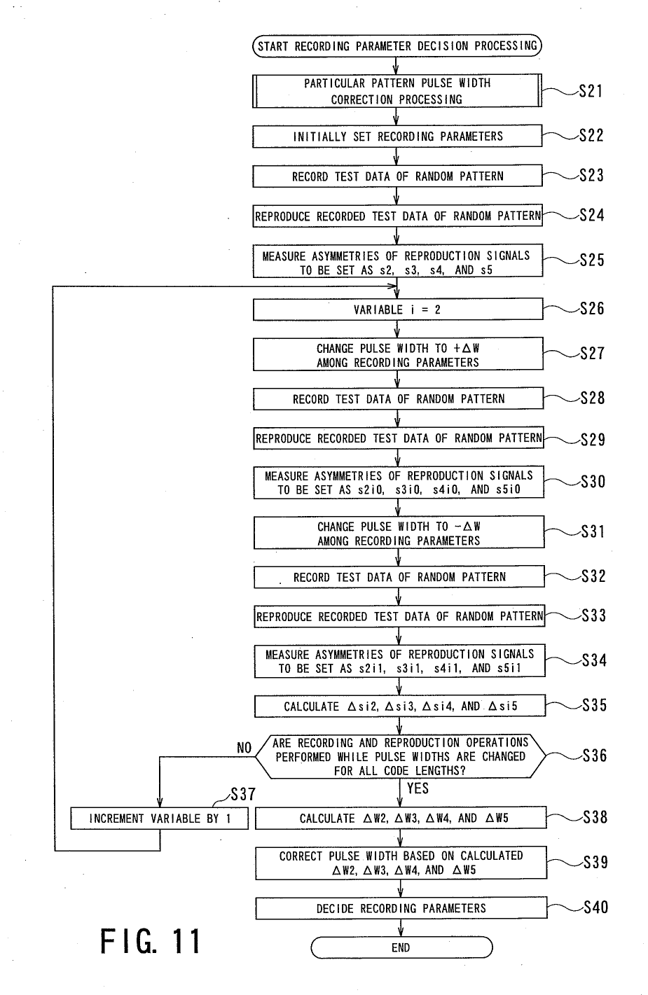

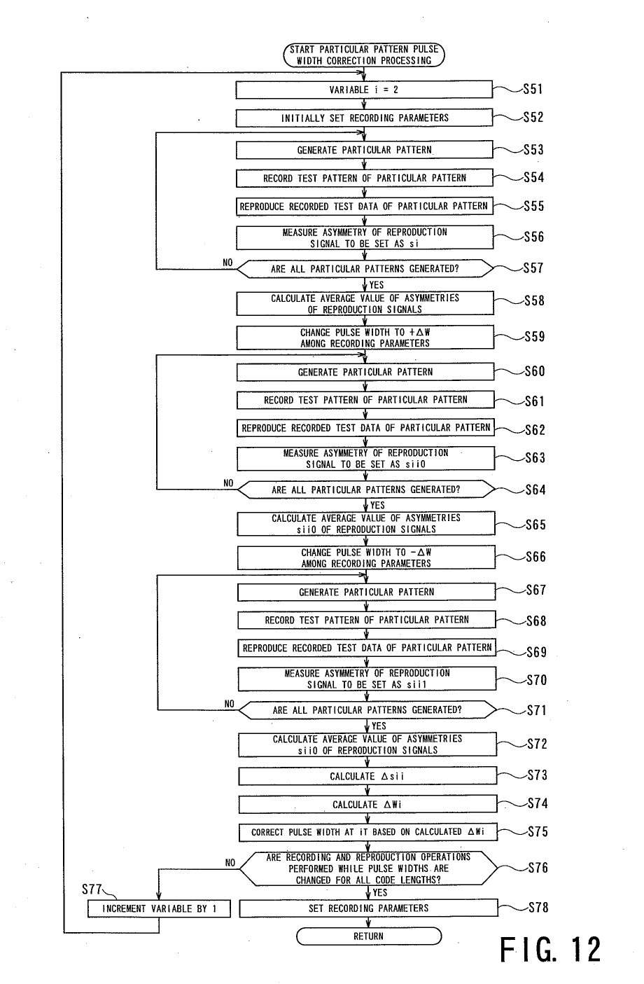

Next, with reference to flowcharts of FIGS. 11 and 12, the recording parameter decision processing in the optical disc apparatus 1 of FIG. 9 will be described. It should be noted that the processing in Steps S22 to S40 of FIG. 11 is similar to that in Steps S to S19 of FIG. 6, and a description thereof will be omitted to avoid the repetition.

In Step S21, the CPU 38 controls the entirety of the optical disc apparatus 1 and executes a particular pattern pulse width correction processing as the coarse adjustment with use of the test data having the particular pattern. A detail of this particular pattern pulse width correction processing is illustrated in a flowchart of FIG. 11.

With reference to the flowchart of FIG. 11, the particular pattern pulse width correction processing in the optical disc apparatus 1 of FIG. 9 will be described.

In Step S51, the CPU 38 sets an initial value of a variable i, which is a variable representing a current code length where the pulse width is changed, as i=2. That is, when the variable i is set as 2, through the following processing, after the recording and reproduction of the test data having the particular pattern are performed, the asymmetry of the reproduction signal is measured. Also, after the pulse width at 2T is changed by +ΔW or −ΔW and the recording and reproduction of the test data having the particular pattern are performed, the asymmetry of the reproduction signal is measured.

In Step S52, the CPU 38 reads out the initial values of the recording parameters (for example, the recording power, the write strategy, and the like) used for recording the user data on the optical disc 42 from the ROM 39, and initially sets the recording parameters used for used for recording the user data on the optical disc 42 on the basis of the read initial values of the recording parameters.

In Step S53, in accordance with the control of the CPU 38, the particular pattern generator 45 sets a particular pattern formed by a particular code length (for example, 2T, 3T, and the like) of the test data used when the recording and reproduction operation is performed on the optical disc 42 to measure the asymmetry of the reproduction signal, and generates the set particular pattern. To be more specific, as illustrated in FIG. 10, a particular pattern (for example, a particular pattern A or the like among a particular patterns A to D) where all the inter-symbol interferences related to the two code lengths xT and yT (the shortest code length≦x, y≦the longest code length) are included and also the DSV (Digital Sum Value) becomes is generated.

In this case, for example, a particular pattern where all the inter-symbol interferences related to 2T and 11T are included and also the DSV becomes 0 is generated.

The particular pattern generator 45 outputs the test data having the particular pattern based on the thus generated particular pattern to the laser driver circuit 17.

In Step S54, the CPU 38 controls the optical pickup 5, the RF amplifier 23, the focus control circuit 25, the tracking control circuit 27, and other components via the bus 37, and uses the initially set recording parameters to perform the recording operation of the test data of a predetermined random pattern on a predetermined area of the optical disc 42 (PCA (Power calibration Area)). With this configuration, with use of the initially set recording parameters, the data of the predetermined random pattern is recorded in the predetermined area of the optical disc 42.

In Step S55, the CPU 38 controls the optical pickup 5, the RF amplifier 23, the focus control circuit 25, the tracking control circuit 27, and other components via the bus 37, and performs the reproduction operation of the test data of the predetermined random pattern which has been recorded by using the initially set recording parameters.

In Step S56, the CPU 38 controls the data reproduction circuit 31, the equalizer 32, and the evaluation index measurement circuit 35, and measures the asymmetry of the reproduction signal at the time of recording and reproducing the test data having the predetermined pattern.

To be more specific, the equalizer 32 uses an arbitrary PR characteristic to convert the reproduction signal input from the data reproduction circuit 31 into an equalized reproduction signal close to the arbitrary PR characteristic, and outputs the converted equalized reproduction signal to the evaluation index measurement circuit 35.

The evaluation index measurement circuit 35 calculates (measures) the asymmetry as the evaluation index of the reproduction signal on the basis of the equalized reproduction signal input from the equalizer 32.

The evaluation index measurement circuit 35 supplies data related to the calculated (measured) asymmetry to the CPU 38 via the bus 37. The CPU 38 obtains the data related to the asymmetry (the asymmetry of the reproduced signal at the time of recording and reproducing the test data having the particular pattern) which is supplied from the evaluation index measurement circuit 35. The data regarding this asymmetry of the reproduction signal includes data related to the asymmetry si of the reproduced signal at the code length iT. In this case, the data regarding this asymmetry of the reproduction signal includes data related to the asymmetry s2 of the reproduced signal at the code length 2T. The thus obtained data related to the asymmetries is temporarily stored in the RAM 39.

In Step S57, the CPU 38 determines whether all the particular patterns (for example, four particular patterns A to D in the case of the example illustrated in FIG. 10) are generated in the particular pattern generator 45 or not.

In Step S57, when it is determined that all the particular patterns (for example, the four particular patterns A to D in the case of the example illustrated in FIG. 10) are not generated (in other words, when it is determined that a particular pattern which has not been generated by the particular pattern generator 45 exists among the particular patterns), the process is returned to Step S53, and the processing in Step S2 and subsequent steps is repeatedly executed. With this configuration, all the particular patterns are sequentially generated by the particular pattern generator 45. The recording and reproduction operations are performed by using the test data of the respective particular patterns are performed, and the asymmetry of the reproduction signal is measured.

Of course, among the plurality of existing isotopes, only the test data having one particular pattern may be recorded.

In Step S57, when it is determined that all the particular patterns (for example, in the case of the example illustrated in FIG. 10, the four particular patterns A to D) are generated, in Step S58, the CPU 38 subsequently obtains data related to the asymmetries calculated when the test data having all the particular patterns is recorded and reproduced, and calculates an average value of the asymmetries in all the particular patterns on the basis of the thus obtained data related to the asymmetries.

With this configuration, when the particular patterns are formed by the two code lengths xT and yT (for example, 2T and 11T, etc.), as no consideration is given on three or more continuous inter-symbol interferences, it is possible to suppress the dispersions caused among the four isotopes particular patterns.

In Step S59, the CPU 38 performs the initial setting to change the pulse width at the code length iT among the recording parameters to +ΔW by changing the pulse width adjusting parameter. In this case, by changing the pulse width adjustment parameter, the initial setting is achieved so that the pulse width at the code length 2T among the recording parameters is changed to +ΔW.

At this time, for example, as illustrated in FIGS. 5A and 5C, the pulse width adjusting parameter is changed.

In Step S60, in accordance with the control of the CPU 38, the particular pattern generator 45 sets a particular pattern formed by a particular code length (for example, 2T, 3T, and the like) of the test data used when the recording and reproduction operation is performed on the optical disc 42 to measure the asymmetry of the reproduction signal, and generates the set the particular pattern.

In this case, similarly to the processing in Step S53, for example, such a particular pattern is generated that all the inter-symbol interference related to 2T and 11T are included and also the DSV becomes 0.

In Step S61, the CPU 38 controls the optical pickup 5, the RF amplifier 23, the focus control circuit 25, the tracking control circuit 27, and other components via the bus 37, and uses the initially set recording parameters to perform the recording operation of the test data of the predetermined random pattern in the predetermined area of the optical disc 42 (PCA (Power Calibration Area)). With this configuration, with use of the initially set recording parameters, the data of the predetermined random pattern is recorded in the predetermined area of the optical disc 42.

In Step S62, the CPU 38 controls the optical pickup 5, the RF amplifier 23, the focus control circuit 25, the tracking control circuit 27, and other components via the bus 37, and uses the initially set recording parameters to perform the reproduction operation of the test data of the predetermined random pattern.

In Step S63, the CPU 38 controls the data reproduction circuit 31, the equalizer 32, and the evaluation index measurement circuit 35, and measures the asymmetry of the reproduction signal (the asymmetry of the reproduction signal at each code length) at the time of recording and reproducing the test data of the predetermined random pattern. It should be noted that the specific measurement method is similar to the measurement method described in Step S56, and a description thereof will be omitted to avoid the repetition.

Herein, after the pulse width at iT is changed by +ΔW and the recording and reproduction are performed, the measured asymmetry of the reproduction signal at the code length iT is denoted by sii0. On the other hand, after the pulse width at iT is changed by −ΔW and the recording and reproduction are performed, the measured asymmetry of the reproduction signal at the code length iT is denoted by sii1.

For example, the asymmetry of the reproduction signal at the code length 2T measured after the pulse width at 2T is changed by +ΔW and the recording and reproduction are performed is denoted by s220. On the other hand, for example, the asymmetry of the reproduction signal at the code length 2T measured after the pulse width at 2T is changed by −ΔW and the recording and reproduction are performed is denoted by s221.

In this case, through the processing in Step S63, the asymmetry s220 of the reproduction signal at the code length 2T is calculated.

The evaluation index measurement circuit 35 supplies data related to the calculated (measured) asymmetry to the CPU 38 via the bus 37. The CPU 38 obtains the data related to the asymmetry (the asymmetry of the reproduced signal at the time of recording and reproducing the test data of the random pattern) which is supplied from the evaluation index measurement circuit 35. The data regarding this asymmetry includes data related to the asymmetry s220 of the reproduction signal at the code length 2T.

In Step S64, the CPU 38 determines whether all the particular patterns (for example, four particular patterns A to D in the case of the example illustrated in FIG. 10) are generated in the particular pattern generator 45 or not.

In Step S64, when it is determined that all the particular patterns (for example, the four particular patterns A to D in the case of the example illustrated in FIG. 10) are not generated (in other words, when it is determined that a particular pattern which has not been generated by the particular pattern generator 45 exists among the particular patterns, the process is returned to Step S60, and the processing in Step S60 and subsequent steps is repeatedly executed. With this configuration, all the particular patterns are sequentially generated by the particular pattern generator 45. The recording and reproduction operations are performed by using the test data of the respective particular patterns are performed, and the asymmetry of the reproduction signal is measured.

In Step S64, when it is determined that all the particular patterns (for example, in the case of the example illustrated in FIG. 10, the four particular patterns A to D) are generated, in Step S65, the CPU 38 subsequently obtains data related to the asymmetries calculated when the test data having all the particular patterns is recorded and reproduced, and calculates an average value of the asymmetries sii0 in all the particular patterns on the basis of the thus obtained data related to the asymmetries.

In Step S66, the CPU 38 performs the initial setting to change the pulse width at the code length 1T among the recording parameters to −ΔW by changing the pulse width adjusting parameter. In this case, the initial setting is performed by changing the pulse width adjustment parameter to change the pulse width at the code length 2T among the recording parameter to −ΔW.

At this time, for example, as illustrated in FIGS. 5B and 5D, the pulse width adjusting parameter is changed.

In Step S67, in accordance with the control of the CPU 38, the particular pattern generator 45 sets a particular pattern formed by a particular code length (for example, 2T, 3T, and the like) of the test data used when the recording and reproduction operation is performed on the optical disc 42 to measure the asymmetry of the reproduction signal, and generates the set the particular pattern.

In this case, similarly to the processing in Step S53, for example, such a particular pattern is generated that all the inter-symbol interference related to 2T and 11T are included and also the DSV becomes 0.

In Step S68, the CPU 38 controls the optical pickup 5, the RF amplifier 23, the focus control circuit 25, the tracking control circuit 27, and other components via the bus 37, and uses the initially set recording parameters to perform the recording operation of the test data of the predetermined random pattern in the predetermined area of the optical disc 42 (PCA (Power Calibration Area)). With this configuration, with use of the initially set recording parameters, the data of the predetermined random pattern is recorded in the predetermined area of the optical disc 42.

In Step S69, the CPU 38 controls the optical pickup 5, the RF amplifier 23, the focus control circuit 25, the tracking control circuit 27, and other components via the bus 37, and uses the initially set recording parameters to perform the reproduction operation of the test data of the predetermined random pattern.

In Step S70, the CPU 38 controls the data reproduction circuit 31, the equalizer 32, and the evaluation index measurement circuit 35, and measures the asymmetry of the reproduction signal (the asymmetry of the reproduction signal at each code length) at the time of recording and reproducing the test data of the predetermined random pattern. It should be noted that the specific measurement method is similar to the measurement method described in Step S56, and a description thereof will be omitted to avoid the repetition.

In this case, through the processing in Step S70, the asymmetry s221 of the reproduction signal at the code length 2T is calculated.

The evaluation index measurement circuit 35 supplies data related to the calculated (measured) asymmetry to the CPU 38 via the bus 37. The CPU 38 obtains the data related to the asymmetry (the asymmetry of the reproduced signal at the time of recording and reproducing the test data of the random pattern) which is supplied from the evaluation index measurement circuit 35. The data regarding this asymmetry includes data related to the asymmetry s221 of the reproduction signal at the code length 2T.

In Step S71, the CPU 38 determines whether all the particular patterns (for example, four particular patterns A to D in the case of the example illustrated in FIG. 10) are generated in the particular pattern generator 45 or not.

In Step S71, when it is determined that all the particular patterns (for example, the four particular patterns A to D in the case of the example illustrated in FIG. 10) are not generated (in other words, when it is determined that a particular pattern which has not been generated by the particular pattern generator 45 exists among the particular patterns, the process is returned to Step S67, and the processing in Step S67 and subsequent steps is repeatedly executed. With this configuration, all the particular patterns are sequentially generated by the particular pattern generator 45. The recording and reproduction operations are performed by using the test data of the respective particular patterns are performed, and the asymmetry of the reproduction signal is measured.

In Step S71, when it is determined that all the particular patterns (for example, in the case of the example illustrated in FIG. 10, the four particular patterns A to D) are generated, in Step S72, the CPU 38 subsequently obtains data related to the asymmetries calculated when the test data having all the particular patterns is recorded and reproduced, and calculates an average value of the asymmetries sii1 in all the particular patterns on the basis of the thus obtained data related to the asymmetries.

In Step S73, the CPU 38 calculates the change in the asymmetry Δsii (i=2, 3, 4, or 5) of the reproduction signal at the respective code length (iT) at the time of changing the pulse width at iT by finding out an inclination (θ) of the straight line on the basis of the data related to the thus obtained asymmetry of the reproduction signal at the predetermined code length. That is, in this case, on the basis of the thus obtained data related to the asymmetry s220 of the reproduction signal at the code length 2T and the thus obtained data related to the asymmetry s221 of the reproduction signal at the code length 2T, a change Δs22 in the asymmetry of the reproduction signal at the code length 2T at the time of changing the pulse width at 2T can be found out by way of tan (θ22) from an inclination of the straight line (θ22).

In Step S74, the CPU 38 calculates such a correction amount ΔWi of the pulse width that the current asymmetry at the predetermined code length iT in the optical disc 42 becomes 0 with use of the linear equation illustrated in FIG. 8 on the basis of the calculated Asii0 and Asii1 and further the current asymmetry si of the reproduction signal at the code length iT (the asymmetry of the reproduction signal at the time of using the initial value).

In this case, the CPU 38 calculates such a correction amount ΔW2 of the pulse width that the current asymmetry at the predetermined code length 2T in the optical disc 42 becomes 0 with use of the linear equation illustrated in FIG. 8 on the basis of the calculated Δs220 and Δs221, and further the current asymmetry of the reproduction signals at the code length 2T.

In Step S75, the CPU 38 corrects the previously set initial values on the basis of the calculated pulse width correction amounts ΔWi (the pulse width correction amounts with which the current asymmetries at the respective code length in the optical disc 42 are set as 0).

In Step S76, the CPU 38 determines whether the recording and reproduction operations are performed by changing the pulse width with respect to all the code lengths (for example, 2T, 3T, 4T, 5T, and the like) or not. In Step S76, when it is determined that the recording and reproduction operations are not performed by changing the pulse width with respect to all the code lengths, the CPU 38 increments the variable i by 1 in Step S77. In this case, the variable i is incremented from 2 by 1 and is thus set as 3.

After that, the process is returned to Step S51, and the processing in Step S51 and subsequent steps is repeatedly executed. That is, as the variable i is set as 3, through the following processing, the test data having the particular pattern is recorded and reproduced. Subsequently, the asymmetry of the reproduction signal is measured, and also the pulse width at 3T is changed by +ΔW or −ΔW. Then, the test data having the particular pattern is recorded and reproduced. After that, the asymmetry of the reproduction signal is measured, and the change Δs33 in the measured asymmetry of the reproduction signal at the code length 3T is calculated. Then, on the basis of the calculated Δs33, the previously set initial value of the pulse width at 3T is corrected.

Next, through the repeated execution of the process in Steps S51 to S77, furthermore, the variable i is set as 4 and 5. Through the following processing, the test data having the particular pattern is recorded and reproduced. Subsequently, the asymmetry of the reproduction signal is measured, and also the pulse widths at 4T and 5T are changed by +ΔW or −ΔW. Then, the test data having the particular pattern is recorded and reproduced. After that, the asymmetry of the respective reproduction signals is measured, and the changes Δs44 and Δs55 in the measured asymmetries of the reproduction signals at the code lengths 4T and 5T are calculated. Then, on the basis of the calculated Δs44 and Δs5S, the previously set initial values of the pulse widths at 4T and 5T are corrected.

In Step S78, the CPU 38 decides the current recording parameters (the recording power and the write strategy after the correction) as the recording parameters used for recording the user data on the optical disc 42.

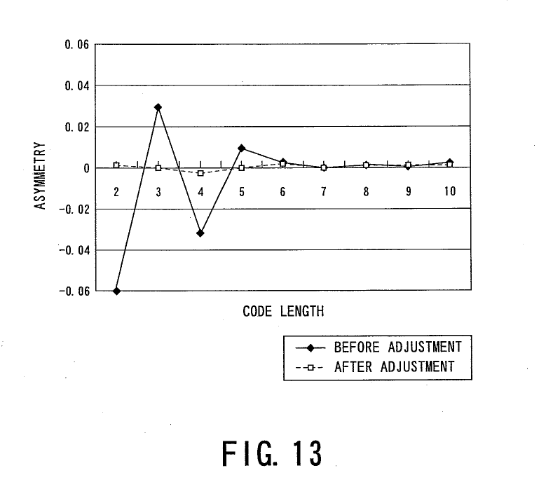

With this configuration, for example, as illustrated in FIG. 13, the asymmetry of the reproduction signal at 2T to 5T can be set close to almost 0 as compared to the stage before the adjustment.

After that, the process is returned to Step S22 of FIG. 11. In Step S22 and subsequent steps, the recording and reproduction operations with use of the test data of the random pattern in consideration of the inter-symbol interference are performed as the fine adjustment. The discrimination for each code length is performed in the Viterbi decoding circuit 33. On the basis of the asymmetry of the reproduction signal is measured as well as the measured asymmetry of the reproduction signal, the pulse width is corrected. While following the corrected pulse width, the recording parameters used for recording the user data on the optical disc 42 are decided.

With this configuration, even when the reproduction signal is not satisfactorily locked in the PLL circuit 29 in the initial stage, as the code discrimination does not need to be performed in the stage of the coarse adjustment, it is possible to form the recording waveforms optimal to further inferior quality optical discs 42.

Therefore, the recording quality (recording integrity) in a case where the user data is recorded on the optical discs 42 can be improved. Also, variations due to the media (recording media) or the optical disc apparatuses 1 are further suppressed, and it is possible to further improve the yield and also achieve the further reduction of the development time.

It should be noted that according to the second embodiment of the present invention, the particular pattern in consideration with the two continuous inter-symbol interferences is used. However, the present invention is not limited to the above-mentioned case. A particular pattern in consideration with three continuous inter-symbol interferences, four continuous inter-symbol interferences, and the like may be generated to be used. In the particular pattern in consideration with the two continuous inter-symbol interference, the number of code lengths is eight and the number of isotopes is four. However, in the particular pattern in consideration with the three inter-symbol interference, the number of code lengths is 16 and the number of isotopes is 32. With this configuration, the dispersions among the asymmetries of the reproduction signals among the isotopes can be further suppressed.

It should be noted that a series of processings described according to the embodiments of the present invention can be executed by software but also executed by hardware.

In addition, according to the embodiments of the present invention, such an example has been described that the steps of the flowchart are processed in a time series following the description order, but the steps may not be necessarily executed. The present invention encompasses a process in which the steps are executed in parallel or individually.

What is claimed is:

1. An optical disc apparatus, comprising:
a change unit configured to change a previously set pulse width at a predetermined code length by a predetermined value;
a measurement unit configured to measure an asymmetry of a reproduction signal at a time of recording and reproducing test data on a disc at least in part by using the pulse width changed by the change unit;
a calculation unit configured to calculate a correction value for correcting the previously set pulse width at the predetermined code length based at least in part on the asymmetry of the reproduction signal measured by the measurement unit; and
a correction unit configured to correct the pulse width at the predetermined code length based at least in part on the correction value calculated by the calculation unit.

2. The optical disc apparatus according to claim 1, further comprising a decision unit configured to decide a recording parameter used for recording user data on the disc based at least in part on the corrected pulse width at the predetermined code length.

3. The optical disc apparatus according to claim 1, wherein the test data comprises a random pattern of test data.

4. The optical disc apparatus according to claim 1, further comprising a generation unit configured to generate a particular pattern formed by a particular code length of the test data, wherein the measurement unit is further configured to measure the asymmetry of the reproduction signal at a time of recording and reproducing test data having the particular pattern generated by the generation unit on the disc and to measure the asymmetry of the reproduction signal at a time of recording and reproducing a random pattern of test data on the disc after a correction processing is performed on the pulse width.

5. The optical disc apparatus according to claim 1, wherein the predetermined code length comprises at least code lengths of 2T, 3T, 4T, and 5T.

6. The optical disc apparatus according to claim 1, wherein the change unit is configured to change the previously set pulse width at the predetermined code length to be expanded or narrowed by the predetermined value.

7. An optical disc recording and reproduction method for an optical disc apparatus, the method comprising:
changing a previously set pulse width at a predetermined code length by a predetermined value;
measuring an asymmetry of a reproduction signal at a time of recording and reproducing test data on a disc at least in part by using the changed pulse width;
calculating a correction value for correcting the previously set pulse width at the predetermined code length based at least in part on the measured asymmetry of the reproduction signal; and
correcting the pulse width at the predetermined code length based at least in part on the calculated correction value.
